(19) United States
(12) Patent Application Publication
(10) Pub. No.: US 2002/0044320 A1
(43) Pub. Date: Apr. 18, 2002

(54) Multicasting in an OCDM network

(75) Inventors: Thomas Pfeiffer, Stuttgart (DE); Wolfgang Korber, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/978,089

(22) Filed: Oct. 17, 2001

(30) Foreign Application Priority Data
Oct. 18, 2000 (DE) 100 51 633.5

(51) Int. Cl. H04B 10/20; H04J 14/00; H04J 14/08

(52) U.S. Cl. 359/136; 359/118

(57) ABSTRACT

The invention is based on an optical network using the OCDM method with a plurality of transmitters, network nodes and receivers which are connected to transmission links, wherein different groups of network nodes are defined in the network and the groups of network nodes evaluate different optical signals.

### BACKGROUND OF THE INVENTION

The invention is based on a priority application DE 100 51 633.5 which is hereby incorporated by reference.

The invention is based on an optical network using the OCDM (Optical Code Division Multiplex) method with a plurality of transmitters, network nodes and receivers which are connected to transmission links, wherein different groups of network nodes are defined in the network and the groups of network nodes evaluate different optical signals.

The invention is also based on a method of transmitting information to different groups of network nodes, wherein optically coded signals are used for the transmission, and wherein a first group of signals are optically coded with a supercode and the optically coded signals are decoded in network nodes, and wherein supercoded signals are evaluated in at least one group of network nodes.

The invention is further based on a transmitter for the transmission of optically coded signals with a broadband light source and a means for generating an optical code, and a coder unit for generating an optical supercode.

A transmitter with filter bank, which is connected to the transmission link into the network, where the filter bank contains a number of filters corresponding to the number of receiver nodes and where the outputs of the filters can be connected to the network via optical switches, or a transmitter with configurable optical filter which directly generates the supercode, serves as component in the network according to the invention.

The invention further relates to a network node in an OCDM network with a decoder for decoding the supercode.

### SUMMARY OF THE INVENTION

Optical networks for the transmission of optical data signals are known from the prior art. Here a fundamental differentiation is made between access networks and transport networks for the transmission of data. The access networks which ensure the access to the consumer are characterised by complex network structures. The system diversity of these primarily service-specific access systems is very great. Within a communications network, the access network has the function of enabling the subscribers to access switching devices, for example servers. From his location, each subscriber must firstly be connected to a supply node in order to avail himself of the offered services. All information technology means are basically suitable for the connection of the subscribers. In the long-distance network, the routing of the telecommunications traffic is concentrated in point-to-point connections between the different network- and switching nodes. On the other hand, in the access network very different requirements must be fulfilled. Standardised functions (BORSCHT) must be implemented for the technical cooperation between the subscriber exchange and the terminals. The subscribers themselves are not homogeneously distributed over the entire access area; rather, there are local areas with high subscriber densities as well as areas in which the subscribers occur only sporadically. On the basis of the relevant communications requirements, it is possible to distinguish between highly differing subscriber groups, such as private customers and smaller or larger business customers to whom appropriate transmission-technology solutions must be offered. It is in the case of the access networks that a willingness is required on the part of the network operator to invest a large capital outlay. The components are exposed to environmental influences and must each be made available individually to the access network subscribers.

A method for constructing access networks is known from the as yet unpublished German Application 199 04 940.8. A transmission system of this kind for coded optical signals consists of optical transmission lines, optical splitters, and optionally optical amplifiers and serves to transmit coded, multiplexed, optical signals. Each transmitter contains a coder in which the signals to be transmitted are coded prior to their transmission into the optical transmission network. The coding takes place optically, e.g. by frequency coding using an optical filter. Each receiver which wishes to receive the data of a specific transmitter must contain a decoder which is tuned to the coder of this specific transmitter. In the simplest case the frequency ranges which are conductive for optical signals and the frequency ranges which are blocked for optical signals are the same in the coder and in the decoder. The CDM (Code Division Multiplex) methods are particularly suitable for the transmission of not too high bit rates. The CDM method is suitable for use as multipoint-to-multipoint network, such as for example a LAN. In contrast to broadcasting (point-to-multipoint connection including all the receiving points) the previously known CDM methods cannot establish a multicast function, i.e. a point-to-multi-point connection only to selected receiving points.

The network according to the invention and the network components according to the invention facilitate multicast connections.

### BRIEF DESCRIPTION OF THE DRAWING

The components and method described in the subordinate claims facilitate advantageous further developments and improvements of the optical network. Exemplary embodiments of the invention are illustrated in the drawing and explained in detail in the following description.

In the drawing:

FIG. 1 illustrates an optical network and

FIG. 2 illustrates a transmitter with filter bank of an optical network.

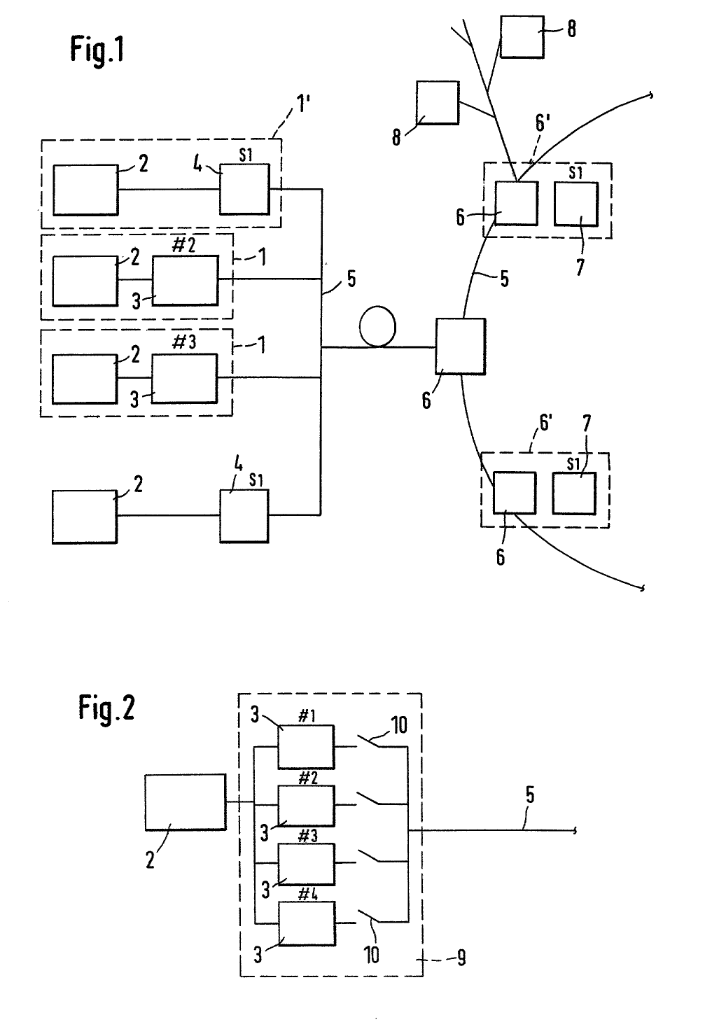

FIG. 1 shows four transmitters 1 and 1′ whose outputs are connected via transmission links 5 to one or more network nodes 6 and 6′. The network nodes 6 and 6′ are connected to further network nodes 6 and 6′ via further transmission links 5. The transmitters 1′ contain a broadband light source 2 which are connected to an optical coder 3. In place of the optical coders 31 coding means for supercode 4 are contained in the transmitters 1′. A network node 6′ is subscriber of a multicast group selected by the supercode but for this purpose does not require any decoding means or conversion means in addition to the decoding means and conversion means also contained in the other network nodes 6. Thus each network node 6 is a potential multicast node 6′. A further transmission link 5 and a plurality of optical receivers 8 are connected to the network node 6′.

The light of the broadband light source 2 is coded in the optical coder 3. The result is a broadband structured signal in the form of a comb pattern which can be received and evaluated by a receiver with tuned decoders. The signal of such a source with a code 2 or a code 4 can be received by every network node 6 in the network. The light of the transmitters ′ passes through a coding means for supercode 4 instead of the optical coder 3. This supercode can be evaluated only by special network nodes 6′. The impression of the supercode takes place in the coder 4 either using a configurable optical filter or according to the embodiment in FIG. 2.

FIG. 2 illustrates a broadband light source 2 which is connected to a filter bank 9. The filter bank 9 contains optical coders 3 for the individual coding of the relevant transmitter signals 1 to 4. The outputs of the optical coders 3 are connected to optical switches 10. The superimposition of the codes selected via the switches 10 yields the supercode. The relevant outputs are connected to the network. The described method also facilitates a transmission of multicast signals from a network node 6. In this case this network node contains a coder for supercode 4. This coder for supercode 4 codes the optical signals such that only a selected number of receivers in the access area can decode the signal. In this way it is possible to provide that one group of receivers receive signals simultaneously while another group does not receive these signals. A method of this kind can be used for the transmission of highly differing services. Information services sent to a group of users are conceivable for example. Only this group of users, which pay for this purpose, receive the information simultaneously by the use of the special code. The other users present in the same access network cannot decode the data.

1. An optical network using the OCDM method with a plurality of transmitters, network nodes and receivers which are connected to transmission links, wherein different groups of network nodes are defined in the network and the groups of network nodes evaluate different optical signals.

2. A method of transmitting information to different groups of network nodes, wherein optically coded signals are used for the transmission, and wherein at least one group of signals is optically coded with a supercode and the optically coded signals are decoded in network nodes, and wherein supercoded signals are evaluated in at least one group of network nodes.

3. A method according to claim 2, wherein the supercode consists of a superimposition of individual codes of the group of network nodes to be addressed.

4. A transmitter for the transmission of optically coded signals with a broadband light source and a means for generating an optical code, wherein a coder unit for generating a supercode is contained.

5. A transmitter with filter bank which is connected to the transmission link into the network, wherein the filter bank contains a number of filters corresponding to the number of receiver nodes and wherein the outputs of the filters are connected to the network via optical switches.

6. A network node in an OCDM network with a decoder for decoding the supercode.
